(19) United States
(12) Patent Application Publication
(10) Pub. No.: US 2024/0103350 A1
(43) Pub. Date: Mar. 28, 2024

(54) Light source assembly and projection device

(71) Applicant: Coretronic Corporation, Hsin-Chu (TW)

(72) Inventors: KAI-JIUN WANG, Hsin-Chu (TW); CHANG-HSUAN CHEN, Hsin-Chu (TW); KUAN-LUN CHEN, Hsin-Chu (TW); SHANG-WEI CHEN, Hsin-Chu (TW)

(21) Appl. No.: 18/372,155

(22) Filed: Sep. 25, 2023

(30) Foreign Application Priority Data
Sep. 26, 2022 (CN) 202211185463.0

(51) Int. Cl. G03B 21/28; F21V 7/00

(52) U.S. Cl. CPC G03B 21/28; F21V 7/0033

(57) ABSTRACT

A light source assembly includes a first annular reflector, a second annular reflector and a plurality of first light source modules. The first annular reflector has a first reflective surface. The second annular reflector is coaxial with the first annular reflector. A radius of the first annular reflector is greater than that of the second annular reflector. The second annular reflector has a second reflective surface facing the first reflective surface. The first light source modules take a central axis of the first annular reflector as a center and annularly arranged around the center. The first light source modules provide first beams to the first reflective surface, which reflects the first beams to the second reflective surface. The second reflective surface reflects the first beams and makes the first beams emit along a direction parallel to a central axis of the second annular reflector. A projection device is also provided.

### CROSS-REFERENCE TO RELATED APPLICATION

This application claims the priority benefit of China application (No. 202211185463.0), filed on Sep. 26, 2022. The entirety of the above-mentioned patent application is hereby incorporated by reference herein and made a part of this specification.

### TECHNICAL FIELD

The disclosure relates to a light source assembly suitable for a projection device, and a projection device having the light source assembly.

### BACKGROUND

With the requirements of the market for the brightness, color saturation, and service life of projection devices, the market demand for projection devices with more light sources is getting higher and higher. However, with the increasing quantity of light sources, the projection device needs to use more optical elements such as mirrors and beam splitters to integrate the beams emitted by the light sources. In this way, it will not only cause the volume of the projection device to be too large, but also increase the cost of the projection device. In addition, due to the limit of the arrangement of the light sources, the light spot formed by the beams from each of the light sources after being integrated by optical elements has the problem of uneven brightness, which affects the image quality of the projection device.

The information disclosed in this “BACKGROUND” section is only for enhancement understanding of the background of the disclosure and therefore it may contain information that does not form the prior art that is already known to a person of ordinary skill in the art. Furthermore, the information disclosed in this “BACKGROUND” section does not mean that one or more problems to be solved by one or more embodiments of the disclosure were acknowledged by a person of ordinary skill in the art.

### SUMMARY

A light source assembly provided by the present disclosure includes a first annular reflector, a second annular reflector and a plurality of first light source modules. The first annular reflector has an inner side and an outer side opposite to each other. The inner side has a first reflective surface. The second annular reflector is arranged to be coaxial with the first annular reflector. A radius of the first annular reflector is greater than a radius of the second annular reflector. The second annular reflector has a second reflective surface. The second reflective surface faces the first reflective surface. The plurality of first light source modules take a central axis of the first annular reflector as a center and are annularly arranged around the center. The plurality of first light source modules is configured to provide a plurality of first beams to the first reflective surface. The first reflective surface is configured to reflect the plurality of first beams to the second reflective surface. The second reflective surface is configured to reflect the plurality of first beams and make the plurality of first beams emit out along a direction parallel to a central axis of the second annular reflector.

A projection device provided by the present disclosure includes an illumination system, a light valve, and a projection lens. The illumination system is configured to provide an illumination beam. The light valve is arranged on a transmission path of the illumination beam and configured to convert the illumination beam into an image beam. The projection lens is arranged on a transmission path of the image beam and configured to project the image beam out of the projection device. The illumination system includes the aforementioned light source assembly.

Other objectives, features, and advantages of the disclosure will be further understood from the further technological features disclosed by the embodiments of the disclosure wherein there are shown and described preferred embodiments of this disclosure, simply by way of illustration of modes best suited to carry out the disclosure.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic view of a light source assembly according to an embodiment of the present disclosure;

FIG. 2 is a schematic view of the light source assembly of FIG. 1 guiding a first beam;

FIG. 3 is a top view of the light source assembly of FIG. 1;

FIG. 4 is a sectional view of the light source assembly, taken along the line A-A in FIG. 3;

FIG. 5 is a schematic view of a light source assembly guiding a first beam according to another embodiment of the present disclosure;

FIG. 6 is a sectional view of a light source assembly according to another embodiment of the present disclosure;

FIG. 7 is a schematic view of a light source assembly guiding a first beam according to another embodiment of the present disclosure;

FIG. 8 is a top view of a light source assembly according to another embodiment of the present disclosure;

FIG. 9 is a schematic view of a light source assembly guiding a first beam according to another embodiment of the present disclosure;

FIG. 10 is a top view of the light source assembly of FIG. 9;

FIG. 11 is a schematic view of the light spot of the first beam of the light source assembly according to another embodiment of the present disclosure;

FIG. 12 is a schematic diagram of a projection device according to an embodiment of the present disclosure; and

FIG. 13 is a schematic diagram of a projection device according to another embodiment of the present disclosure.

### DETAILED DESCRIPTION OF PREFERRED EMBODIMENTS

In the following detailed description of the preferred embodiments, reference is made to the accompanying drawings which form a part hereof, and in which is shown by way of illustration specific embodiments in which the disclosure may be practiced. In this regard, directional terminology, such as “top”, “bottom”, “front”, “back”, etc., is used with reference to the orientation of the Figure(s) being described. The components of the disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the disclosure. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing”, “faces”, and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

The present disclosure provides a light source assembly, which has the advantages of small volume, low cost, and uniform brightness. The present disclosure also provides a projection device, which has the advantages of small volume, low cost, and improved image quality. Other advantages and objectives of the disclosure may be further illustrated by the technical features broadly embodied and described as follows.

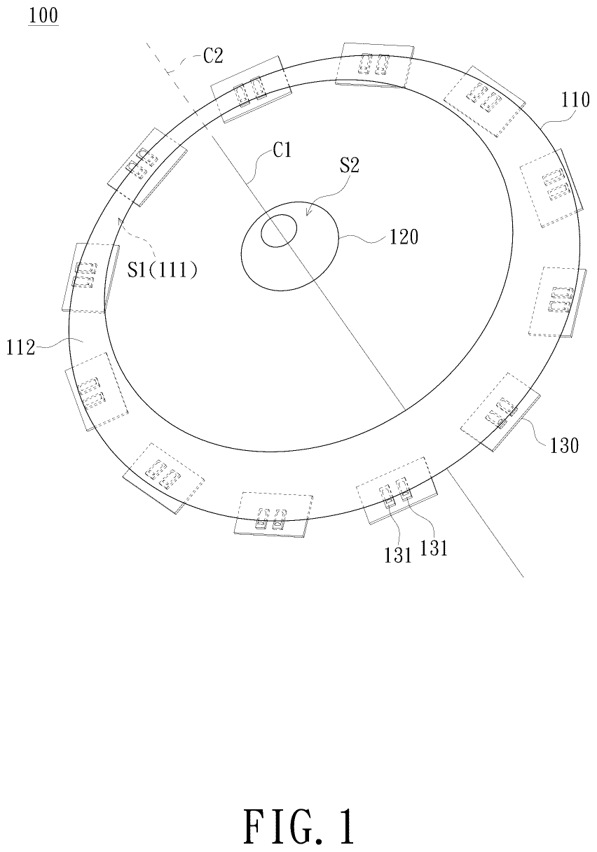

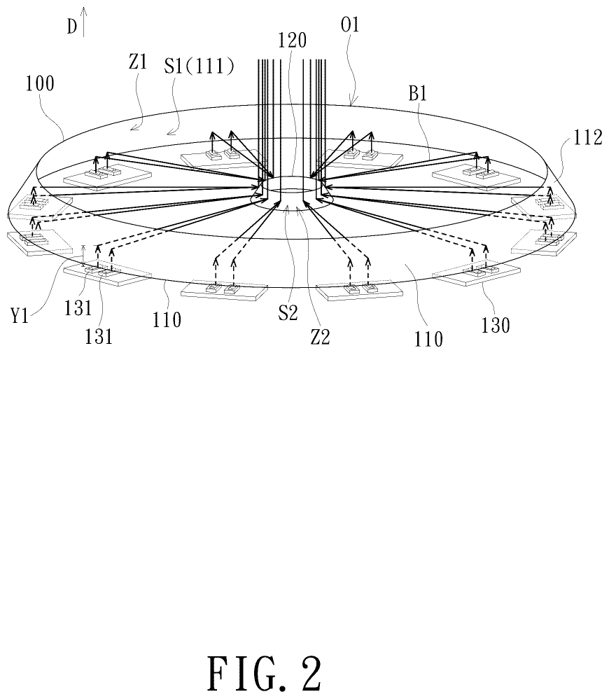

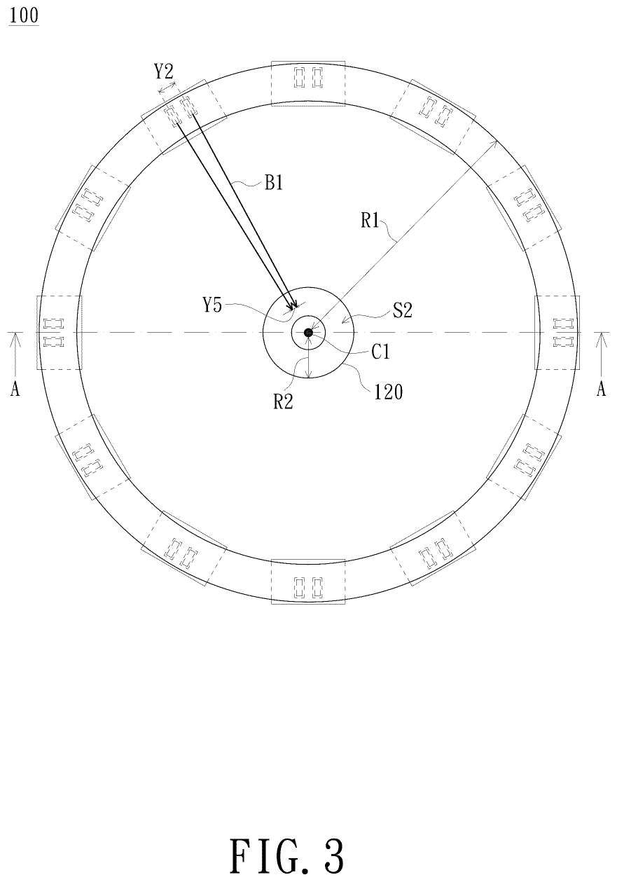

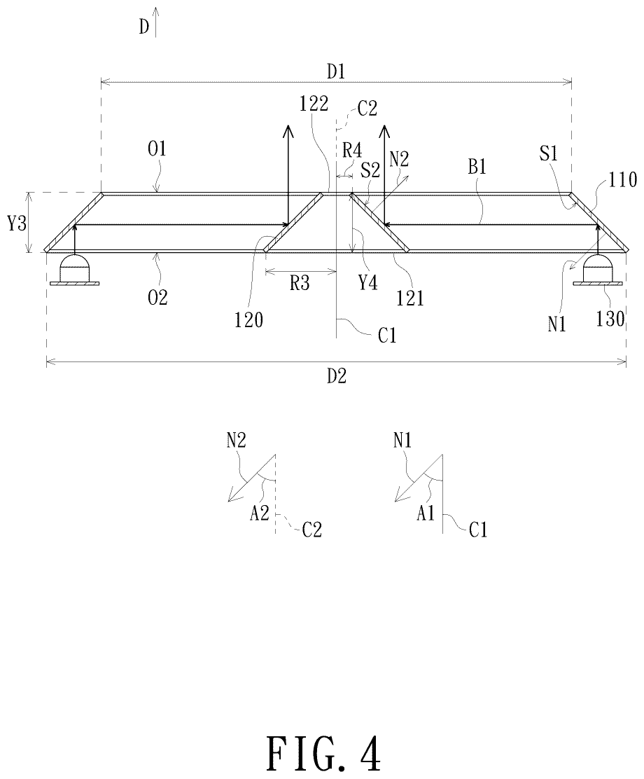

FIG. 1 is a schematic view of a light source assembly according to an embodiment of the present disclosure. FIG. 2 is a schematic view of the light source assembly of FIG. 1 guiding a first beam. FIG. 3 is a top view of the light source assembly of FIG. 1. FIG. 4 is a sectional view of the light source assembly, taken along the line A-A in FIG. 3. Referring to FIGS. 1, 2, and 3, the light source assembly 100 includes a first annular reflector 110, a second annular reflector 120, and a plurality of first light source modules 130. The first annular reflector 110 has an inner side 111 and an outer side 112 opposite to each other. The inner side 111 has a first reflective surface S1. The second annular reflector 120 is arranged to be coaxial with the first annular reflector 110. For example, the central axis C1 (shown in FIG. 1) of the first annular reflector 110 is substantially coincided with the central axis C2 (shown in FIG. 1) of the second annular reflector 120. Referring to FIGS. 2, 3, and 4, the radius R1 of the first annular reflector 110 (shown in FIG. 3) is greater than the radius R2 of the second annular reflector 120 (shown in FIG. 3). The second annular reflector 120 has a second reflective surface S2, and the second reflective surface S2 faces the first reflective surface S1 of the first annular reflector 110. The first light source modules 130 take the central axis C1 of the first annular reflector 110 as a center and are annularly arranged around the center. Each of the first light source modules 130 is configured to provide at least one first beam B1 to the first reflective surface S1. The first reflective surface S1 is configured to reflect the first beams B1 to the second reflective surface S2. The second reflective surface S2 is configured to reflect the first beams B1 and make the first beams B1 emit out along the direction D parallel to the central axis C2 of the second annular reflector 120. For example, the first beams B1 reflected by the second reflective surface S2 emit in the direction D substantially parallel to the central axis C2 of the second annular reflector 120. It should be noted that part of the first light source modules 130 and other detailed structures in FIG. 3 are omitted in FIG. 4 to clearly present the light source assembly 100.

Referring to FIGS. 1 and 2, each of the first light source modules 130 may have a plurality of light emitting elements 131, and this embodiment is exemplified by two light emitting elements 131. Each of the light emitting elements 131 is configured to provide the first beam B1. The first light source modules 130 and the first reflective surface S1 are arranged face to face with each other, and along the direction D, the distance Y1 (shown in FIG. 2) between each of the light emitting elements 131 of each of the first light source modules 130 and the first reflective surface S1 is equal. In this way, the brightness of each of the first beams B1 incident on the first reflective surface S1 is more consistent, and the thickness of the light source assembly 100 in the direction D can be reduced, thereby further reducing the volume of the light source assembly 100. The distance Y1 can be adjusted according to the actual application requirements. In addition, as shown in FIG. 3, the first light source modules 130 can be arranged to be equidistant from each other, for example, on the reference plane perpendicular to the central axis C1 of the first annular reflector 110, and the first light source modules 130 can be arranged in radial directions (in the directions perpendicular to the central axis C1) so that the first beams B1 incident on the first reflective surface S1 are more uniform. In addition, the first light source module 130 may be an excitation light source module. The light emitting elements 131 include, for example, one or more light emitting diodes (LEDs), one or more laser diode (LD), or a combination thereof, or other suitable light sources.

Referring to FIGS. 2 and 4, the first annular reflector 110 is in the shape of a frustum, for example, and the side of the frustum is the first reflective surface S1. The first annular reflector 110 has a first opening O1 and a second opening O2. The first opening O1 and the second opening O2 are respectively located on the two sides of the first reflective surface S1. Specifically, the first opening O1 and the second opening O2 are respectively located on the upper and lower sides of the first reflective surface S1 in the gravity direction, and the aperture D1 of the first opening O1 is smaller than the aperture D2 of the second opening O2. Further, the second opening O2 can be used for the first beams B1 to pass through and incident on the first reflective surface S1, and then the first beams B1 can be emitted from the first opening O1 after being reflected by the first reflective surface S1. As shown in FIG. 3, it is to be noted that the distance Y2 between any two adjacent first beams B1 incident on the first reflective surface S1 is greater than the distance Y5 between any two adjacent first beams B1 incident on the second reflective surface S2. Specifically, because the first reflective surface S1 can be an annular arc surface, the first reflective surface S1 can reflect the first beams B1 in radial directions toward the central axis C1 (shown in FIG. 4) so that the first beams B1 can converge on the second reflective surface S2. In this way, the second reflective surface S2 can reflect the first beams B1 more accurately, so that the first beams B1 can be emitted along the direction D (shown in FIG. 4), and thereby improving the light utilization of the light source assembly 100.

Referring to FIGS. 1 and 2, the second annular reflector 120 is in the shape of a cone or a frustum, for example, and this embodiment is exemplified by a shape of a frustum. The second reflective surface S2 of the second annular reflector 120 can be an annular arc surface, so the second reflective surface S2 can reflect the first beams B1 more accurately to emit along the direction D, thereby further improving the light utilization of the light source assembly 100.

Referring to FIG. 4, the second annular reflector 120 has a bottom 121 and a top 122. The bottom 121 and the top 122 are respectively located on the two sides of the second reflective surface S2. Specifically, the top 122 and the bottom 121 are respectively located on the upper and lower sides of the second reflective surface S2 in the gravity direction, and the radius R3 of the bottom 121 is greater than the radius R4 of the top 122. In the embodiment, the gravity direction is parallel to the direction D shown in FIG. 4. The bottom 121 of the second annular reflector 120 is adjacent to the second opening O2 of the first annular reflector 110, and the top 122 of the second annular reflector 120 is adjacent to the first opening O1 of the first annular reflector 110. The bottom 121 and the top 122 of this embodiment are shown as openings; however, the bottom 121 and the top 122 can be light transmitting structures in other embodiments. In this embodiment, the distance Y3 between the first opening O1 and the second opening O2 of the first annular reflector 110 can be equal to the distance Y4 between the bottom 121 and the top 122 of the second annular reflector 120. In other words, the thickness of the first annular reflector 110 and the second annular reflector 120 in the direction D may be equal to each other to further reduce the volume of the light source assembly 100. Further, in an embodiment, the included angle A1 between the normal N1 of the first reflective surface S1 and the central axis C1 of the first annular reflector 110 can be 42° to 48°, that is, 42°<A1<48°. Similarly, the included angle A2 between the normal N2 of the second reflective surface S2 and the central axis C2 of the second annular reflector 120 can be 42° to 48°, that is, 42°<A2<48°. In this way, the first opening O1 of the first annular reflector 110 can be substantially coplanar with the top 122 of the second annular reflector 120, and the second opening O2 can be substantially coplanar with the bottom 121, thus further reduce the thickness of the light source assembly 100 in the direction D. In an embodiment, the included angles A1 and A2 are, for example, about 45°.

Referring to FIG. 2, the first annular reflector 110 and/or the second annular reflector 120 in this embodiment can be circular. The first reflective surface S1 and/or the second reflective surface S2 include at least one reflective area, wherein FIG. 2 is exemplified by that the first annular reflector 110 includes a reflective area Z1 and the second annular reflector 120 includes a reflective area Z2. In detail, the reflective areas Z1 and Z2 are, for example, annular. The reflective area Z1 can contain the entire first reflective surface S1, and the reflective area Z2 can contain the entire second reflective surface S2. In this embodiment, the materials of the first annular reflector 110 and the second annular reflector 120 can include metal, and the surfaces of the metal can form the reflective areas Z1 and Z2 respectively. In an embodiment, the materials of the first annular reflector 110 and the second annular reflector 120 can include glass, and the glass can be provided with a reflective layer respectively, and the reflective layers can form the reflective area Z1 and the reflective area Z2.

By adopting a plurality of first light source modules 130 arranged in an annular manner and using the first annular reflector 110 and the second annular reflector 120 arranged in a coaxial manner to guide the first beams B1, the light source assembly 100 of this embodiment can effectively simplify the design of the optical path, and thus having the advantages of small size and low cost. In addition, because the first light source modules 130 of this embodiment take the central axis C1 of the first annular reflector 110 as a center and are arranged in an annular manner, the beams formed by the integration of the first beams B1 through the first annular reflector 110 and the second annular reflector 120 can have uniform brightness.

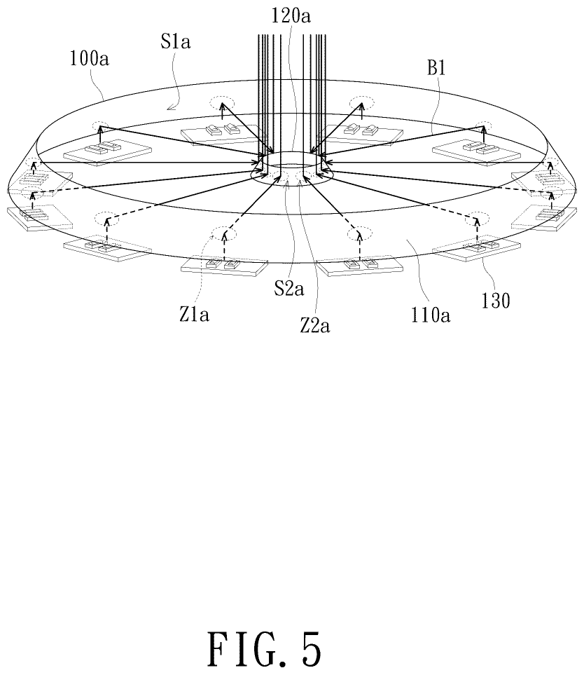

FIG. 5 is a schematic view of a light source assembly guiding a first beam according to another embodiment of the present disclosure. The structure and advantages of the light source assembly 100a of this embodiment are similar to those of the embodiment of FIG. 1, and only the differences will be described below. Referring to FIG. 5, the first reflective surface S1a of the first annular reflector 110a includes a plurality of reflective areas Z1a, and the second reflective surface S2a of the second annular reflector 120a includes a plurality of reflective areas Z2a. It should be noted that in order to clearly present the features of the first annular reflector 110a and the second annular reflector 120a, FIG. 5 simplifies the quantity of the first beams B1 of each first light source module 130 into one. In this embodiment, the reflective area Z1a is a partial area of the first reflective surface S1a reflecting the first beams B1, and the reflective area Z2a is a partial area of the second reflective surface S2a reflecting the first beams B1. The reflective area Z1a of the first reflective surface S1a can be arranged towards the corresponding first light source module 130a, and the reflective area Z2a of the second reflective surface S2a can be arranged towards the corresponding reflective area Z1a of the first reflective surface S1a. Similarly, the materials of the first annular reflector 110a and the second annular reflector 120a can include glass, and the glass is provided with a plurality of reflective layers, for example, which can form a plurality of reflective areas Z1a and Z2a respectively.

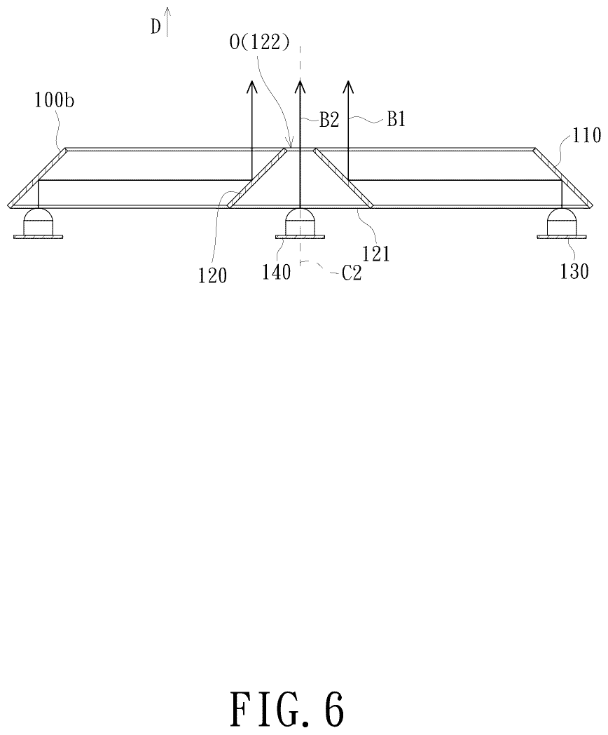

FIG. 6 is a sectional view of a light source assembly according to another embodiment of the present disclosure. The structure and advantages of the light source assembly 100b of this embodiment are similar to those of the embodiment of FIG. 1, and only the differences will be described below. Referring to FIG. 6, the light source assembly 100b further includes, for example, a second light source module 140. The second annular reflector 120 may be in the shape of a frustum, and the top 122 of the second annular reflector 120 includes an opening O. The second light source module 140 is arranged on the central axis C2 of the second annular reflector 120. The second light source module 140 is configured to provide at least one second beam B2, and the second beam B2 passes through the opening O along the central axis C2. Further, the wavelength of the second beam B2 may be the same or different from that of the first beams B1. The first beam B1 and the second beam B2 may include a red light beam, a green light beam, a blue light beam, an infrared light beam, an ultraviolet light beam or a beam of other colored light. For example, the first beam B1 may include a blue beam, and the second beam B2 may include a red beam. In an embodiment, the first beam B1 may include a visible light beam, and the second beam B2 may include an infrared light beam. Incidentally, in this embodiment, the bottom 121 of the second annular reflector 120 includes an opening, and the second light source module 140 is arranged adjacent to the bottom 121 and configured to provide the second beam B2 towards the opening. In this way, the second beam B2 can be emitted from the bottom 121 to the top 122 and pass through the opening O in the direction D substantially parallel to the central axis C2. However, in another embodiment, the second light source module 140 is, for example, arranged inside the second annular reflector 120. In addition, the structure of the bottom 121 may not be limited to the opening. In one embodiment, the bottom 121 may be a light transmitting structure.

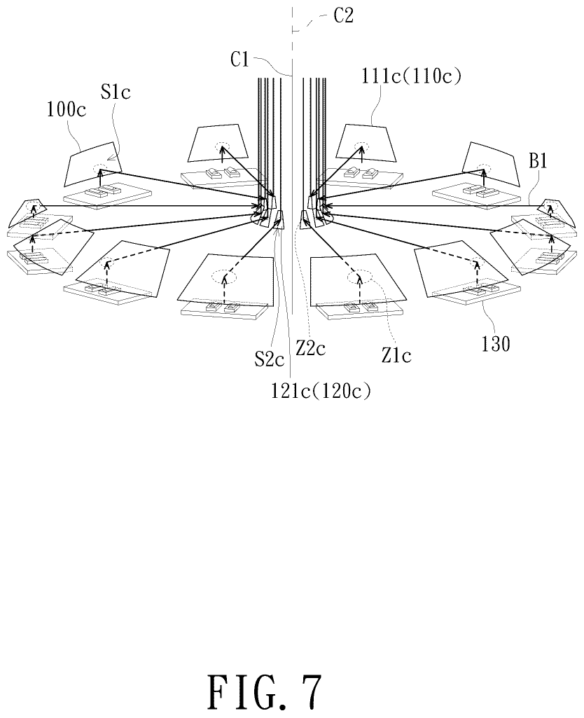

FIG. 7 is a schematic view of a light source assembly guiding a first beam according to another embodiment of the present disclosure. The structure and advantages of the light source assembly 100c of this embodiment are similar to those of the embodiment of FIG. 1, and only the differences will be described below. In addition, to clearly present the features of the light source assembly 100c, FIG. 7 simplifies the quantity of the first beams B1 of each first light source module 130 into one. Referring to FIG. 7, the first annular reflector 110c and/or the second annular reflector 120c can include a plurality of mirrors, wherein FIG. 7 shows that the first annular reflector 110c includes a plurality of mirrors 111c and the second annular reflector 120c includes a plurality of mirrors 121c as an example. Each of the mirrors 111c takes the central axis C1 of the first annular reflector 110c as the center and are arranged annularly and separated from each other. The distance from each mirror 111c to the central axis C1 is equal. The first reflective surface S1c includes the inside surfaces of the mirrors 111c. Specifically, the first reflective surface S1c of this embodiment can be surrounded by the inside surfaces of the mirrors 111c, and the first reflective surface S1c is a discontinuous surface. Each of the mirrors 121c takes the central axis C2 of the second annular reflector 120c as the center and are arranged annularly and separated from each other. The distance from each mirror 121c to the central axis C2 is equal. The second reflective surface S2c includes the outside surfaces of the mirrors 121c. Specifically, the second reflective surface S2c of this embodiment can be surrounded by the outside surfaces of the mirrors 121c, and the second reflective surface S2c is a discontinuous surface. The first reflective surface S1c and/or the second reflective surface S2c include a plurality of reflective areas, wherein FIG. 7 shows that the first reflective surface S1c includes a plurality of reflective areas Z1c and the second reflective surface S2c includes a plurality of reflective areas Z2c as an example. The reflective areas Z1c are located on the mirrors 111c, and the reflective areas Z2c are located on the mirrors 121c. In detail, the reflective areas Z1c and the reflective areas Z2c are respectively located on the inside surfaces of the mirrors 111c and the outside surfaces of the mirrors 121c, and the mirrors 111c and the mirrors 121c can be located on the optical paths of the first beams B1. For example, the reflective area Z1c located on the mirror 111c can be arranged toward the corresponding first light source module 130, and the reflective area Z2c located on the mirror 121c can be arranged toward the corresponding reflective area Z1c. In this embodiment, the mirrors 111c and the mirrors 121c are arc-shaped mirrors, for example. The materials of the mirrors 111c and the mirrors 121c can include metal or glass, wherein the glass can be provided with a reflective layer respectively, which are configured to reflect the first beams B1. The reflective layers can be arranged on the whole glass or on the partial areas of the glass, wherein the partial areas are the areas where the first beams B1 enter the mirrors 111c and/or the mirrors 121c.

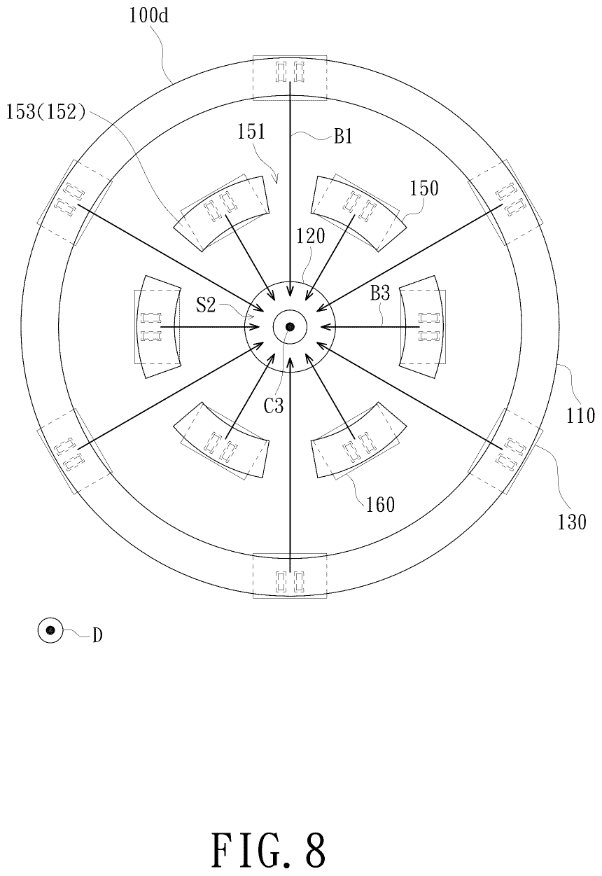

FIG. 8 is a top view of a light source assembly according to another embodiment of the present disclosure. The structure and advantages of the light source assembly 100d of this embodiment are similar to those of the embodiment of FIG. 1, and only the differences will be described below. Referring to FIG. 8, the light source assembly 100d may further include a third annular reflector 150 and a plurality of third light source modules 160. The third annular reflector 150 is arranged between the first annular reflector 110 and the second annular reflector 120, and the first annular reflector 110, the second annular reflector 120 and the third annular reflector 150 are coaxial. Each of the third light source modules 160 takes the central axis C3 of the third annular reflector 150 as a center and is arranged in an annular manner, and the third light source modules 160 are respectively misaligned with the first light source modules 130 in the radial directions of the third annular reflector 150. The third annular reflector 150 may have a plurality of light transmitting parts 151 and a plurality of reflective parts 152. The light transmitting parts 151 are configured to make the first beams B1 from the first reflective surface S1 pass through. It should be noted that FIG. 8 simplifies the quantity of the first beams B1 of each first light source module 130 into one to present other features of the light source assembly 100d. The third light source modules 160 are configured to provide the third beams B3. The reflective parts 152 are configured to reflect the third beams B3 to the second reflective surface S2. The second reflective surface S2 is configured to reflect the third beams B3 and make the third beams B3 emit along the direction D parallel to the central axis C2 of the second annular reflector 120, to further improve the brightness of the beams provided by the light source assembly 100d.

In this embodiment, the third annular reflector 150 may include a plurality of mirrors 153, and each of the mirrors 153 is spaced along the circumferential direction of the third annular reflector 150, for example. Specifically, the mirrors 153 may form the reflective parts 152, and the gaps between each mirror 153 may form the light transmitting parts 151. In an embodiment, the third annular reflector 150 can be in a circular shape. The part of the third annular reflector 150 for the incidence of the third beams B3 can form the reflective parts 152, and the part for the incidence of the first beams B1 can have an opening, which can be used as a light transmitting part 151. In this embodiment, it can be understood that although the third annular reflector 150 and the third light source modules 160 are arranged between the first annular reflector 110 and the second annular reflector 120, the third annular reflector 150 and the third light source modules 160 can be arranged at the periphery of the first annular reflector 110 in another embodiment, so that the first annular reflector 110 is located between the third annular reflector 150 and the second annular reflector 120. Further, because the first annular reflector 110 is located between the third annular reflector 150 and the second annular reflector 120, the first annular reflector 110 can have light transmitting parts 151 for the third beams B3 to pass through and reflective parts 152 for reflecting the first beams B1. In addition, the third light source modules 160 of this embodiment can be equidistant from each other to improve the uniformity of the beams. In addition, the quantity of the first light source modules 130 and that of the third light source modules 160 are not limited to that shown in FIG. 8 and can be adjusted according to the actual needs. Other features of the third light source module 160 are roughly the same as those of the first light source module 130, and no redundant detail is to be given herein.

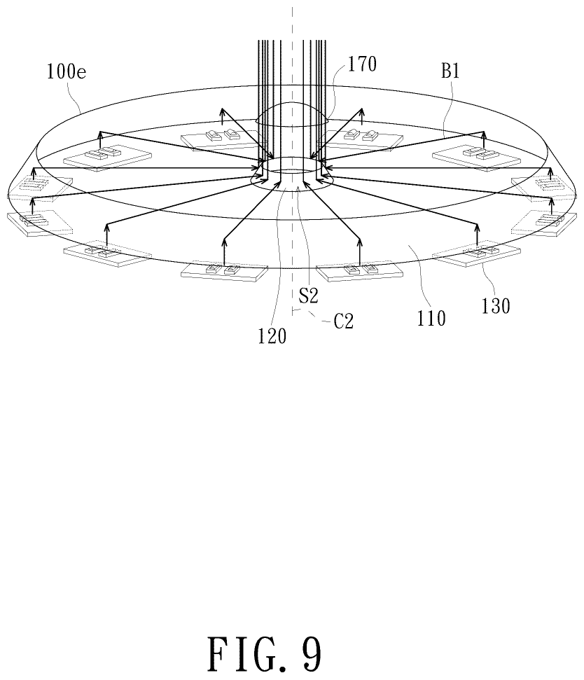

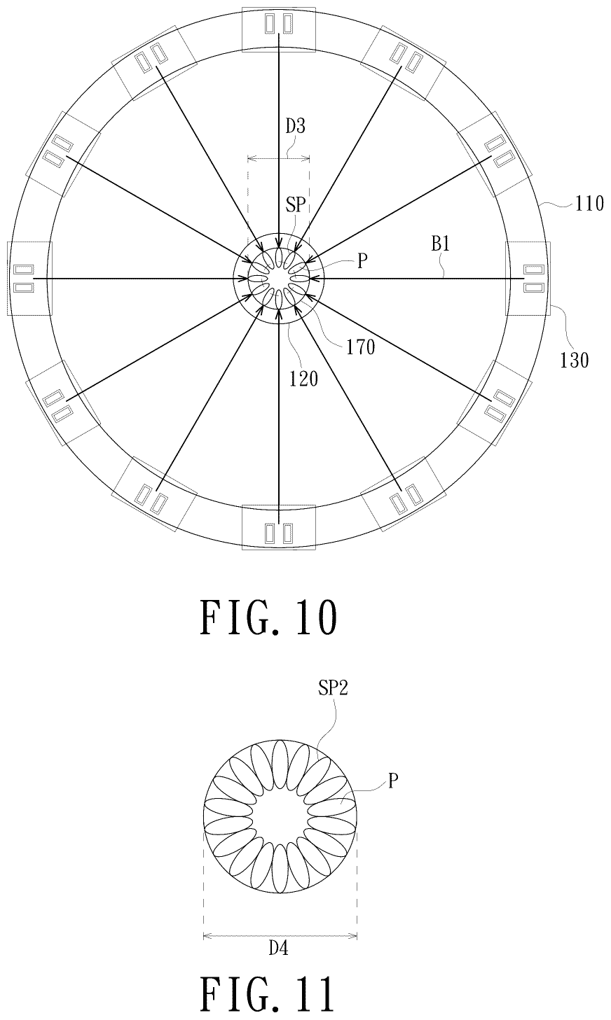

FIG. 9 is a schematic view of a light source assembly guiding a first beam according to another embodiment of the present disclosure. FIG. 10 is a top view of the light source assembly of FIG. 9. The structure and advantages of the light source assembly 100e of this embodiment are similar to those of the embodiment of FIG. 1, and only the differences will be described below. In addition, to clearly present the features of the light source assembly 100e, FIG. 9 simplifies the quantity of the first beams B1 of each first light source module 130 into one. Referring to FIGS. 9 and 10, the light source assembly 100e further includes a focus lens 170, for example. The focus lens 170 is arranged on the central axis C2 of the second annular reflector 120 and is configured to make the first beams B1 from the second reflective surface S2 pass through. In short, the focus lens 170 can further converge the first beams B1 from the second reflective surface S2 to further improve the brightness of the light spot SP formed on the focus lens 170 per unit area. The focus lens 170 of the embodiment is, for example, a convex lens, but the disclosure does not limit the structure and quantity of the focus lens 170. In addition, because the first light source modules 130 are arranged in an annular manner in this embodiment, the sub light spots P formed by the first beams B1 on the focus lens 170 can be arranged in an annular manner, and each sub light spot P can form a circular or an elliptic light spot SP on the focus lens 170.

It is to be noted that the first light source modules 130 are arranged in a circular manner; thus, even if the quantity of the first light source modules 130 is increased to improve the brightness of the light spot SP, the diameter D3 of the light spot SP on the focus lens 170 will not change accordingly. For example, referring to FIG. 11, if a large quantity of first light source modules (not shown) are used, the quantity of sub-light spots P will increase accordingly, but the diameter D4 of the light spot SP2 and the diameter D3 of the light spot SP in FIG. 10 are roughly the same. In this way, the optical elements located downstream of the optical path of the focus lens 170 (shown in FIG. 10) do not need to be redesigned due to the change in the quantity of the first light source modules 130, thus further reducing the product cost. It can be understood that although this embodiment describes the above advantages with the light spot SP formed on the focus lens 170, the advantages described in this paragraph are not limited to whether the focus lens 170 is provided. In other words, the light source assemblies 100, 100a, 100b, 100c and 100d of the present disclosure can also have the advantages described in this paragraph.

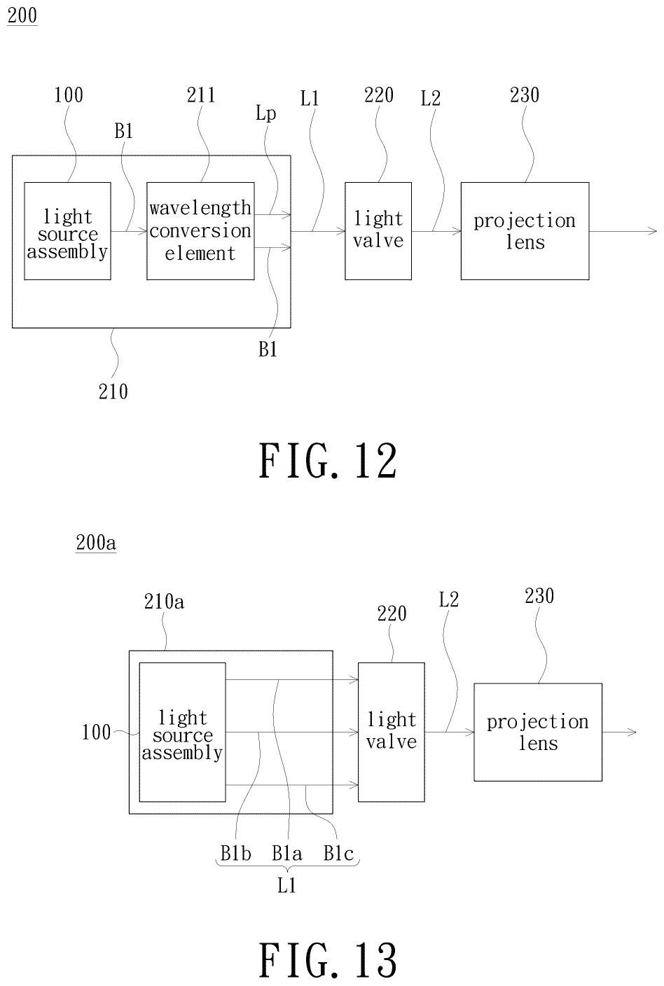

FIG. 12 is a schematic diagram of a projection device according to an embodiment of the present disclosure. Referring to FIG. 12, the projection device 200 includes an illumination system 210, a light valve 220, and a projection lens 230. The illumination system 210 is configured to provide an illumination beam L1. The light valve 220 is arranged on the transmission path of the illumination beam L1. The light valve 220 is configured to convert the illumination beam L1 into an image beam L2. The projection lens 230 is arranged on the transmission path of the image beam L2. The projection lens 230 is configured to project the image beam L2 out of the projection device 200. The illumination system 210 includes a light source assembly 100, 100a, 100b, 100c, 100d, or 100e, and this embodiment uses the light source assembly 100 as an example.

Refer to FIGS. 1 and 11 together. In this embodiment, the features of the light source assembly 100 of the illumination system 210 have been described in detail above, and no redundant detail is to be given herein. In addition, the illumination system 210 of this embodiment further includes, for example, a wavelength conversion element 211. The wavelength conversion element 211 is arranged on the transmission path of the first beam B1 from the second annular reflector 120 and is configured to convert the first beam B1 into a converted beam Lp. The first beam B1 and the converted beam Lp form the illumination beam L1 by the wavelength conversion element 211 in a time interval. The illumination beam L1 includes at least one of the first beam B1 and the converted beam Lp. In detail, the wavelength conversion element 211 may include a wavelength conversion part and a light transmitting part (not shown), and the wavelength conversion part and the light transmitting part may take turns entering the transmission path of the first beam B1. Further, when the first beam B1 is incident on the wavelength conversion part, the wavelength of the first beam B1 is changed by the wavelength conversion part to form the converted beam Lp. On the other hand, when the first beam B1 is incident on the light transmitting part, the light transmitting part can allow the first beam B1 to pass through or reflect the first beam B1. In this embodiment, the wavelengths of the first beams B1 can be the same as each other. For example, each first beam B1 may include a blue beam. Incidentally, in this embodiment, the wavelength conversion part may include a wavelength conversion material, and the wavelength conversion material may include a fluorescent material, a phosphorescent material (e.g., phosphor), or a nano material (e.g., quantum dot), but the disclosure is not limited thereto.

Please refer to FIG. 13. In another embodiment, the projection device 200a is similar to the projection device 200 of FIG. 12, and the main differences are as follows. In this embodiment, the projection device 200a includes an illumination system 210a, a light valve 220 and a projection lens 230. The light source assembly 100 of the illumination system 210a includes a plurality of light emitting elements capable of emitting a first beam B1a, a first beam B1b, and a first beam B1c with different wavelengths. In detail, the illumination system 210a of this embodiment can be provided with a plurality of first light source modules 130, and the light emitting elements on each first light source module 130 can provide the first beam B1a, the first beam B1b, and the first beam B1c with different wavelengths. For example, the first beam B1a, the first beam B1b, and the first beam B1c can respectively include a red beam, a green beam, and a blue beam. The light emitting elements can simultaneously or sequentially emit the first beam B1a, the first beam B1b, and the first beam B1c. The illumination beam L1 includes at least one of the first beam B1a, the first beam B1b, and the first beam B1c. The illumination beam L1 can be guided to the light valve 220 by the first annular reflector 110 and the second annular reflector 120. The projection device 200a of this embodiment does not need optical elements such as wavelength conversion elements, so the production cost required by the projection device 200a is low.

In another embodiment, the illumination system of the projection device may further include a plurality of light source assemblies 100. Each of the light source assemblies 100 emits one of a first beam B1a, a first beam B1b and a first beam B1c with different wavelengths. The illumination system may further include a light guide assembly (not shown). The light guide assembly includes, for example, a plurality of beam-splitting elements. The light guide assembly is configured to guide the first beam B1a, the first beam B1b, and the first beam B1c to the light valve 220. In this embodiment, because the quantity of the light source assemblies 100 is plural, more first light source modules 130 can be accommodated to increase the light intensity of the projection device.

Please refer to FIGS. 12 and 13 together. The light valve 220 is, for example, a digital micromirror device (DMD), a liquid crystal on silicon (LCoS), or a liquid crystal display (LCD), but not limited thereto. In addition, this embodiment does not limit the quantity of the light valves. For example, the projection device 200 of this embodiment can adopt a single-chip liquid crystal display panel or a three-chip liquid crystal display panel structure, but the present disclosure is not limited thereto.

The projection lens 230 includes, for example, one or more optical lenses, and the diopters of the optical lenses may be the same or different from each other. For example, the aforementioned optical lenses may include a biconcave lens, a biconvex lens, a concave-convex lens, a convex-concave lens, a plano-convex lens, and a plano-concave lens, or any combination of the above non-planar lenses. On the other hand, the projection lens 230 may also include a flat optical lens. The present disclosure does not limit the specific structure of the projection lens 230.

Compared with the prior art, by adopting the light source assembly 100, the projection devices 200, 200a of this embodiment can have the advantages of small size, low cost, and good image quality.

In summary, by adopting a plurality of first light source modules arranged in an annular manner and using the first annular reflector and the second annular reflector arranged in a coaxial manner to guide the first beams, the light source assembly of the present disclosure can effectively simplify the design of the optical path, and thus has the advantages of small size and low cost. In addition, because the first light source modules of the present disclosure take the central axis of the first annular reflector as a center and are arranged in an annular manner, the beams formed by the integration of the first beams through the first annular reflector and the second annular reflector can have uniform brightness. The projection device of the present disclosure has the advantages of small volume, low cost and good image quality due to adopting the aforementioned light source assembly.

The foregoing description of the preferred embodiment of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described to best explain the principles of the disclosure and its best mode practical application, thereby enabling persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the invention” or the like is not necessary limited the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the disclosure as defined by the following claims. Moreover, no element and component in the disclosure is intended to be dedicated to the public regardless of whether the element or component is explicitly recited in the following claims. Furthermore, the terms such as the first annular reflector, the second annular reflector, the first reflective surface, the second reflective surface, the first light source module, the second light source module, the first opening and the second opening are only used for distinguishing various elements and do not limit the number of the elements.

What is claimed is:

1. A light source assembly, comprising:
a first annular reflector, having an inner side and an outer side opposite to each other, wherein the inner side has a first reflective surface;
a second annular reflector, arranged to be coaxial with the first annular reflector, wherein a radius of the first annular reflector is greater than a radius of the second annular reflector, the second annular reflector has a second reflective surface, and the second reflective surface faces the first reflective surface; and
a plurality of first light source modules, taking a central axis of the first annular reflector as a center and annularly arranged around the center, wherein the plurality of first light source modules are configured to provide a plurality of first beams to the first reflective surface,
wherein the first reflective surface is configured to reflect the plurality of first beams to the second reflective surface, and the second reflective surface is configured to reflect the plurality of first beams and make the plurality of first beams emit out along a direction parallel to a central axis of the second annular reflector.

2. The light source assembly according to claim 1, wherein:
the first annular reflector is in a shape of a frustum and has a first opening and a second opening, the first opening and the second opening are respectively located on two sides of the first reflective surface, and an aperture of the first opening is smaller than an aperture of the second opening.

3. The light source assembly according to claim 2, wherein:
the second annular reflector is in a shape of a cone or a frustum and has a bottom and a top, the bottom and the top are respectively located on two sides of the second reflective surface, a radius of the bottom is greater than a radius of the top, the bottom of the second annular reflector is adjacent to the second opening of the first annular reflector, and the top of the second annular reflector is adjacent to the first opening of the first annular reflector.

4. The light source assembly according to claim 3, wherein a distance between the first opening and the second opening of the first annular reflector is equal to a distance between the bottom and the top of the second annular reflector.

5. The light source assembly according to claim 1, wherein an included angle between a normal of the first reflective surface and the central axis of the first annular reflector is 42° to 48°, and an included angle between a normal of the second reflective surface and the central axis of the second annular reflector is 42° to 48°.

6. The light source assembly according to claim 1, further comprising a second light source module, wherein the second annular reflector is in a shape of a frustum and has a bottom and a top, the top comprises an opening, the second light source module is arranged on the central axis of the second annular reflector, the second light source module is configured to provide a second beam, and the second beam passes through the opening along the central axis of the second annular reflector.

7. The light source assembly according to claim 1, wherein each of the plurality of first light source modules has a plurality of light emitting elements, each of the plurality of light emitting elements is configured to provide the first beam, the plurality of first light source modules are arranged face to face with the first reflective surface, and a distance between each of the plurality of light emitting elements of each of the plurality of first light source modules and the first reflective surface is equal.

8. The light source assembly according to claim 1, wherein the first annular reflector and/or the second annular reflector are in a circular shape, and the first reflective surface and/or the second reflective surface comprise at least one reflective area.

9. The light source assembly according to claim 1, wherein the first annular reflector and/or the second annular reflector comprise a plurality of mirrors, the plurality of mirrors of the first annular reflector take the central axis of the first annular reflector as a center and are arranged annularly and separated from each other, the first reflective surface comprises inside surfaces of the plurality of mirrors of the first annular reflector, the plurality of mirrors of the second annular reflector take the central axis of the second annular reflector as a center and are arranged annularly and separated from each other, the second reflective surface comprises outside surfaces of the plurality of mirrors of the second annular reflector, and the first reflective surface and/or the second reflective surface comprise a plurality of reflective areas respectively located on the plurality of mirrors.

10. The light source assembly according to claim 1, wherein a material of the first annular reflector and/or the second annular reflector comprises metal or glass.

11. The light source assembly according to claim 1, wherein the plurality of first light source modules is equidistant from each other.

12. The light source assembly according to claim 1, wherein a distance between any two adjacent first beams emitted from the first reflective surface is greater than a distance between any two adjacent first beams incident on the second reflective surface.

13. The light source assembly according to claim 1, further comprising a third annular reflector and a plurality of third light source modules, wherein:
the third annular reflector is arranged between the first annular reflector and the second annular reflector, the first annular reflector, the second annular reflector, and the third annular reflector are arranged in a coaxial manner, the plurality of third light source modules take a central axis of the third annular reflector as a center and are arranged annularly and are misaligned with the plurality of first light source modules in radial directions of the third annular reflector;
the third annular reflector has a plurality of light transmitting parts and a plurality of reflective parts, the plurality of light transmitting parts is configured to make the plurality of first beams from the first reflective surface pass through, the plurality of third light source modules are configured to provide a plurality of third beams, the plurality of reflective parts are configured to reflect the plurality of third beams to the second reflective surface, and the second reflective surface is configured to reflect the plurality of third beams and make the plurality of third beams emit along a direction parallel to the central axis of the second annular reflector.

14. The light source assembly according to claim 1, further comprising a focus lens arranged on the central axis of the second annular reflector, wherein the focus lens is configured to make the plurality of first beams from the second reflective surface pass through.

15. The light source assembly according to claim 14, wherein a plurality of sub-light spots formed by the plurality of first beams on the focus lens are arranged in an annular manner.

16. A projection device, comprising an illumination system, a light valve, and a projection lens, wherein the illumination system is configured to provide an illumination beam, the light valve is arranged on a transmission path of the illumination beam and configured to convert the illumination beam into an image beam, the projection lens is arranged on a transmission path of the image beam and configured to project the image beam out of the projection device, the illumination system comprises a light source assembly, and the light source assembly comprises:
a first annular reflector, having an inner side and an outer side opposite to each other, wherein the inner side has a first reflective surface;
a second annular reflector, arranged to be coaxial with the first annular reflector, wherein a radius of the first annular reflector is greater than a radius of the second annular reflector, the second annular reflector has a second reflective surface, and the second reflective surface faces the first reflective surface; and
a plurality of first light source modules, taking a central axis of the first annular reflector as a center and annularly arranged around the center, wherein the plurality of first light source modules are configured to provide a plurality of first beams to the first reflective surface,
wherein the first reflective surface is configured to reflect the plurality of first beams to the second reflective surface, and the second reflective surface is configured to reflect the plurality of first beams and make the plurality of first beams emit out along a direction parallel to a central axis of the second annular reflector.

17. The projection device according to claim 16, wherein the illumination system further comprises a wavelength conversion element arranged on a transmission path of the plurality of first beams from the second annular reflector, the wavelength conversion element is configured to convert the plurality of first beams into a converted beam, the plurality of first beams and the converted beam form the illumination beam by the wavelength conversion element in a time interval, and the illumination beam comprises at least one of the plurality of first beams and the converted beam.
